(19) United States
(12) Patent Application Publication
(10) Pub. No.: US 2010/0085984 A1
(43) Pub. Date: Apr. 8, 2010

(54) METHOD AND IP TRANSLATOR FOR TRANSLATING PROTOCOL TO SUPPORT COMPATIBILITY BETWEEN NETWORKS EACH EMPLOYING DIFFERENT TYPES OF PROTOCOLS

(75) Inventors: Myung-ki SHIN, Daejeon-si (KR); Sang-jin JEONG, Daejeon-si (KR); Yong-woon KIM, Cheonan-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/563,726

(22) Filed: Sep. 21, 2009

(30) Foreign Application Priority Data
Oct. 8, 2008 (KR) 10-2008-0098605

(51) Int. Cl. H04J 3/22

(52) U.S. Cl. 370/467

(57) ABSTRACT

A method and Internet Protocol (IP) translator for translating a protocol to support compatibility between networks employing different types of protocols is provided. The IP translator includes a virtual platform to operate at least one operating system (OS) which supports different types of IPs, and a protocol translating unit which is provided on the virtual platform, translates a data packet of one of the different types of IPs into a data packet of another of the different types of IPs, and transmits the translated data packet to an OS which supports the other type of IP. Accordingly, it is possible to simplify the complicated IPv6-IPv4 translation mechanism of the existing dual operating system.

### CROSS-REFERENCE TO RELATED APPLICATION

This application claims the benefit under 35 U.S.C. §119(a) of Korean Patent Application No. 10-2008-0098605, filed on Oct. 8, 2008, the disclosure of which is incorporated by reference in its entirety for all purposes.

### BACKGROUND

1. Field

The following description relates to protocol translation and, more particularly, to a method and Internet Protocol (IP) translator for translating a protocol to support compatibility is between networks employing different types of protocols.

2. Description of the Related Art

IPv4 (Internet Protocol version 4) is the fourth revision in the development of the Internet Protocol (IP) and uses 32-bit addresses, which limits the address space to about 4 billion possible unique addresses. IPv4 is used to allow a number of networks and users to access Internet in no time. However, IPv4 is facing problems with limited IP space address, inefficient packet routing, mobility, security, etc.

To overcome IPv4 address exhaustion and limitations on multimedia real-time processing and network security capabilities, IPv6 has been introduced which uses a 128-bit address to have a much larger address space than IPv4.

IPv6-based networks have been introduced. However, it is difficult to translate existing IPv4-based hosts and routers into IPv6-based ones. More specifically, since the existing Internet is based on IPv4 and IPv6 users need to access IPv4-based Internet, both IPv4 and IPv6 are required to exist together concurrently. Hence, a data packet is subject to protocol translation to transmit the data packet between networks employing different types of protocols.

Conventionally, to support compatibility between networks employing different types of protocols, RFC 2766 NAT-PT (Network Address Translation/Protocol Translation) incorporated in IPv6/IPv4 dual stack operating system is employed according to IPv6-IPv4 packet translation defined by RFC 2765 SIIT (Stateless IP/ICMP Translation) Standard.

In such scheme, a single IPv6/IPv4 dual stack operating system is provided in a protocol translator and a translation module such as NAT-PT is incorporated in the dual stack operating system.

Hence, the protocol translator employs an IPv6-IPv4 dual stack-based operating system. In this case, the translation module needs to be incorporated in the operating system, resulting in a complex system structure. As a result, adding a new translation module or modifying a translation module is not an easy task due to inconvenient access to the system, which causes a limited expansibility. Furthermore, since the translation module is incorporated in a single operating system, if the operating system fails to operate, it is difficult to recover the system or make a dual system.

### SUMMARY

The following description relates to a simplified protocol translation method and apparatus.

Furthermore, the following description relates to a protocol translation method and apparatus which is capable of conveniently adding a new translation module or modifying a translation module and conveniently recovering a system failure and making a dual system.

In one general aspect, an Internet Protocol (IP) translator for translating a protocol to s support compatibility between networks employing different types of protocols is provided. The IP translator includes: a virtual platform to operate at least one operating system (OS) which supports different types of IPs; and a protocol translating unit which is provided on the virtual platform, translates a data packet of one of the different types of IPs into a data packet of another of the different types of IPs, and transmits the translated data packet to an OS which supports the other type of IP.

The protocol translating unit may determine from address information of the data packet if the data packet is subject to IP translation. The protocol translating unit may also perform the IP translation if a specific prefix is included in the address information of the data packet.

The protocol translating unit may determine the IP translation based on stored information about data packets which are subject to protocol translation. If the data packet is determined to be not subject to the protocol translation, the protocol translator may transmit the data packet to an OS which supports an IP of the data packet.

Furthermore, the protocol translating unit may discard the data packet unless the data packet is compliant with the supported IPs.

In another general aspect, a method of translating Internet Protocol (IP) to support compatibility between networks employing different types of protocols is provided. The method includes: providing a virtual space to operate an operating system (OS); installing at least one OS in the virtual space which supports different types of IPs; translating a received data packet into a data packet complying with one of the supported IPs; and transmitting the translated data packet to an OS which supports the one of the supported IPs.

Installing the at least one OS may include installing an additional OS in the virtual space which supports a different type of IP.

Translating the received data packet may include determining if the data packet is subject to IP translation and performing IP translation if the data packet is determined to be subject to the IP translation.

Unless the data packet is determined to be subject to the IP translation, transmitting the translated data packet may include transmitting the data packet to an OS which supports an IP of the data packet.

Translating the received data packet may include determining from address information of the data packet if the data packet is subject to IP translation.

Translating the received data packet may include determining the IP translation of the data packet based on stored information data packets which are subject to protocol translation.

However, other features and aspects will be apparent from the following description, the drawings, and the claims.

### BRIEF DESCRIPTION OF THE DRAWINGS

FIG. 1 is a diagram illustrating a protocol network system with an exemplary protocol translator which translates a protocol to support compatibility between networks employing different types of protocols.

FIG. 2 is a block diagram of an exemplary protocol translator.

FIGS. 3 and 4 are flow charts illustrating an exemplary method of translating a protocol.

Throughout the drawings and the detailed description, unless otherwise described, the same drawing reference numbers refer to the same elements, features, and structures. The relative size and depiction of these elements may be exaggerated for clarity, illustration, and convenience.

### DETAILED DESCRIPTION

The detailed description is provided to assist the reader in gaining a comprehensive understanding of the methods, apparatuses and/or systems described herein. Accordingly, various changes, modifications, and equivalents of the systems, apparatuses, and/or methods described herein will be suggested to those of ordinary skill in the art. Also, descriptions of well-known functions and constructions are omitted to increase clarity and conciseness.

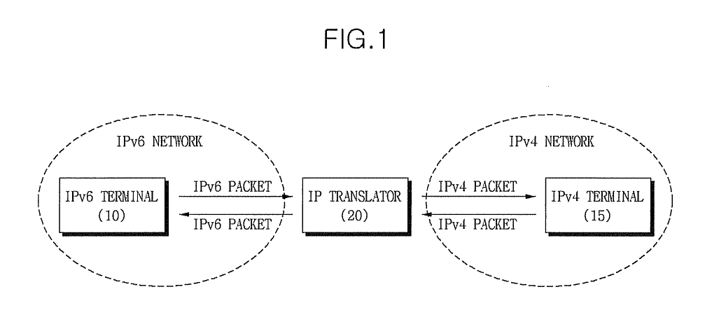

FIG. 1 is a diagram illustrating a protocol network system with an exemplary protocol translator which translates a protocol to support compatibility between networks employing different types of protocols.

The protocol translator 20 performs translation to allow a data packet to be transmitted between different protocol networks, as shown in FIG. 1. In the current example, the protocol networks include, but not limited to, IPv4 and IPv6 networks.

The protocol translator 20 receives an IPv6 data packet from an IPv6 terminal 10 in an is IPv6 network, translates the IPv6 data packet into an IPv4 data packet, and transmits it to an IPv4 terminal 15 in an IPv4 network. On the contrary, the protocol translator 20 receives an IPv4 data packet from the IPv4 terminal 15 in the IPv4 network, translates the IPv4 data packet into an IPv6 data packet, and transmits it to the IPv6 terminal 10 in the IPv6 network. Hence, it is possible to transmit a data packet from one protocol network to the other by means of the protocol translator 20.

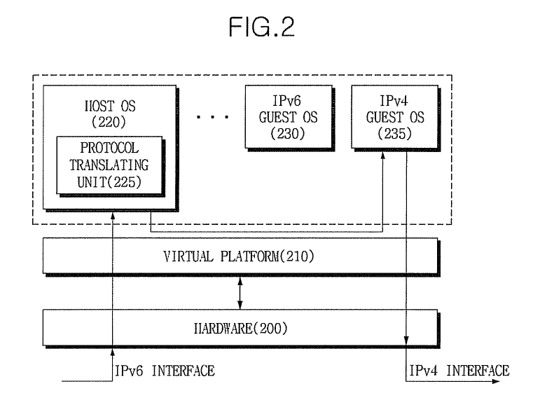

FIG. 2 is a block diagram of an exemplary protocol translator.

The protocol translator 20 includes a virtual platform 210 and a protocol translating unit 225, as shown in FIG. 2.

The virtual platform 210 may be a hypervisor. The virtual platform 210 is provided on an upper layer than translator hardware 200. The virtual platform 210 may create a virtual space on its upper layer, install at least one operating system (OS), and be managed by the operating system. In this case, if software for providing the virtual platform is installed in the translator hardware 200, Domain 0 is created which is a fundamental management area where a Host OS of the hypervisor is executed. The protocol translating unit 225 is implemented on the Host OS. In addition, when additional Guest OSs are installed, Domain 1, Domain 2, etc. are additionally created for virtual OSs. As shown in FIG. 2, an IPv4 Guest OS 235 and an IPv6 Guest OS 230 may be installed in Domain 1 and Domain 2, respectively, to support IPv4 and IPv6 protocols, respectively.

That is, the respective routing tables for IPv4 and IPv6 may be provided in the form of Guest OSs. Accordingly, an IPv4/IPv6 dual stack OS may be implemented, which results in a more advantageous effect in terms of expansibility, duality and stability compared to an existing scheme using an integrated routing table for IPv4 and IPv6 packet routing.

The virtual platform 210 is a kind of virtual hardware created by a virtual program and thus actually does not exist. An application may be executed by a Guest OS which is run by the is virtual platform 210. In this case, an application which is incompatible with an actual Host OS and hardware architecture may be executed by the Guest OS.

The protocol translating unit 225 is implemented on a Host OS for managing the virtual platform 210 as described above. In this case, the Host OS may generally manage the virtual platform 210 which is created when virtual software is installed in the translator hardware 200.

In addition, the Host OS functions as a bridge to send data to a number of Guest OSs which are operated by the virtual platform 210. That is, the Host OS may transmit data packets input through an interface connected to each IP network in the translator hardware 200 to one of Guest OSs operated by the virtual platform. Furthermore, the Host OS may install additional Guest OSs. For example, if a new communication protocol, such as IPvX, other than IPv4 and IPv6 is developed, the Host OS may be configured to install an additional Guest OS which is capable of supporting the new communication protocol. Accordingly, it is possible to provide a protocol translator which is extensible and flexible enough to be adapted to a newly developed technology.

The protocol translating unit 225 performs IPv6-IPv4 translation according to Stateless IP/ICMP Translation (SIIT) defined by RFC 2765. The protocol translating unit 225 translates IPv6 data packets, which are received through IPv6 interface of the translator hardware 200, into IPv4 data packets according to RFC 2765 SIIT Standard. The protocol translating unit 225 then transmits the IPv4 data packets to the IPv4 Guest OS.

More specifically, when receiving a data packet through an interface of the translator to hardware 200, the Host OS determines if it is IPv6 compliant or IPv4 compliant. In case of an IPv6-compliant packet, if it is a general IPv6 packet, it is transmitted to a Guest OS which supports IPv6. However, if it is to be translated to an IPv4-compliant packet, the protocol translating unit 225 translates it into an IPv4-compliant packet according to RFC 2765 SIIT Standard and transmits the IPv4-compliant packet to an IPv4 Guest OS which supports IPv4. On the other hand, in case of an IPv4-compliant packet, if it is a general IPv4 packet, the Host OS transmits it to a Guest OS which supports IPv4. However, if it is to be translated to an IPv6-compliant packet, the protocol translating unit 225 translates it into an IPv6-compliant packet according to RFC 2765 SIIT Standard and transmits the IPv6-compliant packet to an IPv6 Guest OS which supports IPv6.

If the data packet is not compliant with any scheme which is supported by the Guest OS operated by the virtual platform, i.e., if the data packet is not IPv6 or IPv4 compliant, for example, the data packet may be discarded as an error.

The Host OS 220 determines if a data packet received through an interface of the translator hardware 200 is subject to protocol translation. In one example, the protocol translating unit 225 determines if a data packet is subject to IPv6 to IPv4 translation or IPv4 to IPv6 translation. In this case, it is possible to implement a variety of translation conditions according to IPv6-IPv4 translation schemes and a network operator's policy.

The protocol translating unit 225 may determine from address information if a data packet is subject to protocol translation. In one example, the protocol translating unit 225 is configured to perform protocol translation if a portion of address information of a data packet contains effective data. For example, the protocol translating unit 225 determines that an IPv6 packet needs to be translated into an IPv4 packet if the IPv6 packet has a 128-bit address of ‘0’ except the lowest 32 bits of IPv4 address, such as ‘::129.254.254.82’. In addition, the protocol translating unit 225 determines that an IPv6 packet needs to be translated into an IPv4 packet if the IPv6 packet has a 128-bit address with ‘FFFF’ inserted ahead of the lowest 32 bits of IPv4 address, such as ‘::FFFF: 129.254.254.82’.

In another example, the protocol translating unit 225 determines that packet data is subject to protocol translation if the packet data has an IPv6 address with a predefined specific /96 prefix. For example, if a prefix of an address of a IPv6 data packet to be translated into an IPv4 data packet is predefined as AAAA:BBBB:CCCC:DDDD:EEEE:FFFF::/96 by a network operator, an IPv6 data packet of ‘AAAA:BBBB:CCCC:DDDD:EEEE:FFFF::ABCD’ is determined to be subject to protocol translation. In a further example, whether received packet data is subject to protocol translation may be determined based on a packet information list requiring protocol translation which is predefined in the Host OS.

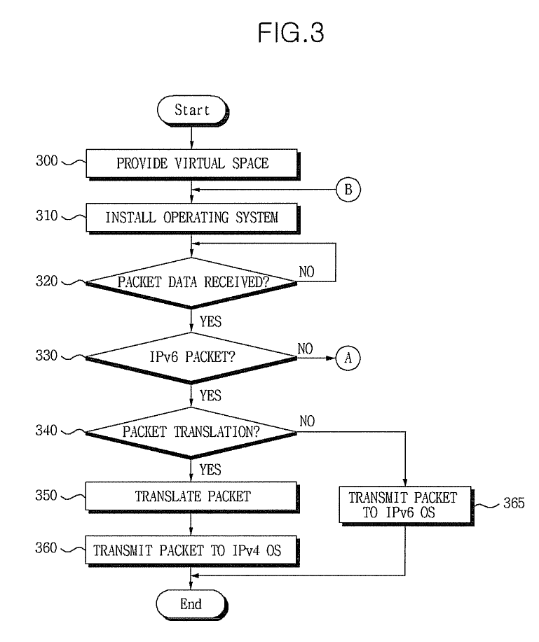

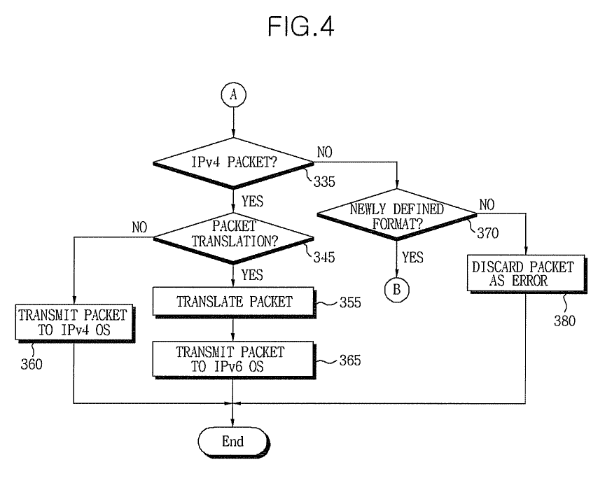

FIGS. 3 and 4 are flow charts illustrating an exemplary method of translating a protocol.

In operation 300, if virtual software is executed on hardware, a virtual space, i.e., a virtual platform, is provided on an upper layer than the hardware.

In operation 310, the virtual platform installs a number of operating systems (OSs) on its upper layer. In the current example, the virtual platform may create a virtual space on its upper layer, install and manage at least one operating system. In this case, if software for providing the virtual platform is installed, Domain 0 is created which is a fundamental management area where a Host OS of the virtual platform, i.e., hypervisor, is executed. In addition, when additional Guest OSs are installed, Domain 1, Domain 2, etc. are additionally created for virtual OSs. In the current example, as shown in FIG. 2, an IPv4 Guest OS and an IPv6 Guest OS may be installed in Domain 1 and Domain 2, respectively, to support IPv4 and IPv6 protocols, respectively.

If a data packet is received through a hardware interface in operation 320, it is determined which protocol address system the data packet has. In operation 330, it is determined if the data packet is an IPv6 packet. In operation 340, it is determined if the data packet is subject to translation.

It is determined if the data packet is subject to IPv6 to IPv4 translation or IPv4 to IPv6 translation. In this case, it is possible to implement a variety of translation conditions according to IPv6-IPv4 translation schemes and a network operator's policy.

For example, it may be determined from address information if the data packet is subject to protocol translation. In one example, the protocol translation is performed if a portion of address information of a data packet contains effective data. For example, the protocol translating unit 225 determines that an IPv6 packet needs to be translated into an IPv4 packet if the IPv6 packet has a 128-bit address of ‘0’ except the lowest 32 bits of IPv4 address, such as ‘::129.254.254.82’. In addition, the protocol translating unit 225 determines that an IPv6 packet needs to be translated into an IPv4 packet if the IPv6 packet has a 128-bit address with ‘FFFF’ inserted ahead of the lowest 32 bits of IPv4 address, such as ‘::FFFF:129.254.254.82’.

In another example, it is determined that packet data is subject to protocol translation if the packet data has an IPv6 address with a predefined specific /96 prefix. For example, if a prefix of an address of a IPv6 data packet to be translated into an IPv4 data packet is predefined as ‘AAAA:BBBB:CCCC:DDDD:EEEE:FFFF::/96 by a network operator, an IPv6 data packet of ‘AAAA:BBBB:CCCC:DDDD:EEEE:FFFF::ABCD’ is determined to be subject to protocol translation. In a further example, whether received packet data is subject to protocol translation may be determined based on a packet information list requiring protocol translation which is predefined in the Host OS. However, the present invention may be implemented in other forms than the above-mentioned examples.

In operation 350, the packet translation is performed if required. The IPv4 packet can be translated into the IPv6 packet according to RFC 2765 SIIT Standard.

In operation 360, the translated packet is transmitted to the IPv4 OS which is operated by the virtual platform. On the contrary, unless the packet translation is necessary, in operation 365, the received data packet is transmitted to the IPv6 OS which is operated by the virtual platform.

If the data packet is determined to be not an IPv6 packet in operation 330, it is determined in operation 335 if it is an IPv4 packet. In operation 345, it is determined if packet translation is necessary. If necessary, in operation 355, the IPv4 packet is translated into an IPv6 packet according to RFC 2765 SIIT Standard. In operation 365, the translated IPv6 packet is transmitted to the IPv6 OS which is operated by the virtual platform. On the other hand, unless the packet translation is necessary, in operation 360, the IPv4 packet is transmitted to the IPv4 OS.

If it is determined to be not an IPv4 packet in operation 335, in operation 370, it is determined if the packet is a newly defined protocol type of data packet. If it is determined to be a newly defined protocol type of data packet, in operation 310, the virtual platform may be implemented to further install a corresponding operating system which supports the newly defined protocol; otherwise, in operation 380, the data packet may be discarded as an error.

The present invention can be implemented as computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

As apparent from the above description, it is possible to simplify a complex IPv6-IPv4 translation module incorporated in the existing dual stack operating system by using a virtual space to operate multiple guest operating systems in single hardware, installing IPv4 and IPv6 operating systems, and performing IPv6-IPv4 translation on received data packets. Accordingly, it is possible to conveniently add new translation modules or modify translation modules. Furthermore, it is possible to recover in real time a system failure on each operating system and make a dual system. In addition, it is possible to provide the respective routing tables for IPv4 and IPv6 by providing a distinct space for each operating system supporting a is protocol. Accordingly, the present invention is advantageous in terms of expansibility, duality, and stability.

Moreover, since additional guest operating systems can be installed, it is possible to provide a protocol translator which is capable of supporting new communication protocols without significant modification thereof.

Additionally, since the present invention can be adapted to a terminal which supports multiple IPs, the terminal supporting both IPv4 and IPv6 can be efficiently operated.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Internet Protocol (IP) translator for translating a protocol to support compatibility between networks employing different types of protocols, the IP translator comprising:
a virtual platform to operate at least one operating system (OS) which supports different types of IPs; and
a protocol translating unit which is provided on the virtual platform, translates a data packet of one of the different types of IPs into a data packet of another of the different types of IPs, and transmits the translated data packet to an OS which supports the other type of IP.

2. The IP translator of claim 1, wherein the virtual platform is a hypervisor.

3. The IP translator of claim 1, wherein the protocol translating unit determines from address information of the data packet if the data packet is subject to IP translation.

4. The IP translator of claim 3, wherein the protocol translating unit performs the IP translation if a specific prefix is included in the address information of the data packet.

5. The IP translator of claim 3, wherein the protocol translating unit performs the IP translation if the address information of the data packet includes effective data.

6. The IP translator of claim 1, wherein the protocol translating unit determines the IP translation based on stored information about data packets which are subject to protocol translation.

7. The IP translator of claim 1, wherein if the data packet is determined to be not subject to the protocol translation, the protocol translator transmits the data packet to an OS which supports an IP of the data packet.

8. The IP translator of claim 1, wherein the virtual platform installs an additional OS which supports a different type of protocol.

9. The IP translator of claim 1, wherein the protocol translating unit discards the data packet unless the data packet is compliant with the supported IPs.

10. A method of translating Internet Protocol (IP) to support compatibility between networks employing different types of protocols, the method comprising:
providing a virtual space to operate an operating system (OS);
installing at least one OS in the virtual space which supports different types of IPs;
translating a received data packet into a data packet complying with one of the supported IPs; and
transmitting the translated data packet to an OS which supports the one of the supported IPs.

11. The method of claim 10, wherein installing the at least one OS comprises installing an additional OS in the virtual space which supports a different type of IP.

12. The method of claim 10, wherein translating the received data packet comprises determining if the data packet is subject to IP translation and performing IP translation if the data packet is determined to be subject to the IP translation.

13. The method of claim 12, wherein unless the data packet is determined to be subject to the IP translation, transmitting the translated data packet comprises transmitting the data packet to an OS which supports an IP of the data packet.

14. The method of claim 12, wherein translating the received data packet comprises determining from address information of the data packet if the data packet is subject to IP translation.

15. The method of claim 12, wherein translating the received data packet comprises determining the IP translation of the data packet based on stored information data packets which are subject to protocol translation.
